(19) United States
(12) Patent Application Publication
(10) Pub. No.: US 2010/0213632 A1
(43) Pub. Date: Aug. 26, 2010

(54) METHOD AND APPARATUS FOR MANUFACTURING MOLDED PLATE

(75) Inventors: Ryuichi Katsumoto, Minami-Ashigara-shi (JP); Hideo Nagano, Minami-Ashigara-shi (JP); Yoshihiko Sano, Minami-Ashigara-shi (JP); Takahiro Hayashi, Minami-Ashigara-shi (JP); Hiromitsu Wakui, Minami-Ashigara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 12/678,443

(22) PCT Filed: Sep. 17, 2008
(86) PCT No.: PCT/JP2008/067215

§ 371 Date: Mar. 16, 2010

(30) Foreign Application Priority Data
Sep. 18, 2007 (JP) 2007-241178

(51) Int. Cl. B29C 47/00

(52) U.S. Cl. 264/167; 425/113

(57) ABSTRACT

According to the present invention, it is possible to easily manufacture a molded plate of a desired size by laminating an unnecessary, inexpensive resin not used as a product in the width direction of a molded plate and simply separating the unnecessary resin after forming the molded plate. Consequently, it is possible to skip a step of cutting the molded plate in the machine direction thereof. Further, it is also possible to skip a polishing step since the cut surfaces of the molded plate in the machine direction thereof can be smoothed. Still further, by arranging a plurality of resins for disposal, it is possible to effectively use the resins when yielding multiple molded plates from one resin sheet.

### TECHNICAL FIELD

The present invention relates to a method and an apparatus for manufacturing a molded plate and, more particularly, to a method and an apparatus for manufacturing a molded plate which is useful in yielding multiple molded plates from one resin sheet and the end faces of which are smooth.

### BACKGROUND ART

Conventionally, a several millimeters-thick extrusion-molded plate has been manufactured using an extrusion molding method. In general, it is a common practice to manufacture a sheet the thickness of which is uniform in the width direction thereof. However, patent document 1 mentioned below describes a method for manufacturing an extruded plate having a thickness distribution in the width direction thereof. In the case of an extrusion-molded plate formed using such an extrusion molding method as described above, lug parts (widthwise end parts of a resin film) are cut off before a molded plate is manufactured since it is difficult for the lug parts to have a desired thickness in a subsequent step.

The present applicant has proposed a method and an apparatus for forming the resin film described in patent document 2 mentioned below, with the aim of improving the recyclability of lug parts to be cut off in a subsequent step and increasing the productivity of an extrusion-molded plate. This method and apparatus form the resin film by laminating a resin for the end parts of the resin film on both widthwise end parts of a resin film main body formed of a resin for the middle part of the resin film, so as to cover the widthwise end parts of the resin film main body with the resin for the end parts. According to the formation method and apparatus, it is possible to reduce a disorder in an inter-resin boundary, while preventing the film separation of the resin for the middle part and the resin for the end parts composing the resin film. It is also possible to improve the recyclability of lug parts.

In addition, patent document 3 mentioned below describes an extrusion method and an apparatus capable of adjusting the width of a product. This extrusion method and apparatus are such that a deckle is adjustably provided in a flow passage and the product width is maintained by adjusting this deckle.

[Patent document 1] Japanese Patent Application Laid-Open No. 2004-082359
[Patent document 2] Japanese Patent Application Laid-Open No. 2004-181753
[Patent document 3] Japanese Patent Application Laid-Open No. 7-76038

Incidentally, in the case of such a molded plate as a light guide plate used for optical applications, among molded plates formed using an extrusion molding method, it is important that the surface roughness of the end faces of a molded resin sheet for introducing light is small and the end faces are smooth (flat).

However, the method described in patent document 2 or 3 requires polishing cut end faces using a mechanical method in order to smooth the end faces after cutting a resin sheet manufactured using an extrusion molding method to a predetermined size with a cutting machine.

The present invention has been accomplished in view of the above-described circumstances. An object of the present invention therefore is to provide a method and an apparatus for manufacturing a molded plate whereby it is possible to obtain a molded plate having smooth end faces without having to polish the end faces of the molded plate and reduce the manufacturing cost thereof.

### DISCLOSURE OF THE INVENTION

In order to achieve the aforementioned object, a first aspect of the present invention provides a method for manufacturing a plurality of molded plates formed to a desired size from a resin for a main body, the method characterized by comprising:

an extrusion step of merging resins of different types in a molten state, one being a resin for a main body and the other being a resin for disposal, and extruding the resins from a die in a sheet-like manner, thereby forming a resin sheet in which the resin for the main body and the resin for disposal are alternately disposed in the width direction of the resin sheet;

a cooling and solidifying step of cooling and solidifying the resin sheet by nipping the resin sheet between a nip roller and a cooling roller and then separating the resin sheet from the cooling roller;

a cutting step of cutting the cooled and solidified resin sheet in the width direction thereof; and

a separation step of separating the cut resin sheet into the resin for the main body and the resin for disposal.

According to the first aspect, since different resins are used respectively as the resin for the main body and the resin for disposal, it is possible to easily separate a resin sheet formed of these resins into the resin for the main body and the resin for disposal. Consequently, it is possible to skip a step of cutting the resin sheet in the machine direction thereof. Thus, it is possible to obtain a molded plate of a desired size by cutting the molded plate in the width direction thereof and separating the resin sheet. In addition, smooth end faces are formed in the resin for the main body from which the resin for disposal has been separated. Accordingly, there is no need to polish the end faces of the molded plate as is done conventionally, even if the molded plate is used for optical applications such as a light guide plate. Furthermore, it is possible to reduce costs further in a case where the resin for disposal separated from the resin for the main body is discarded, by using an inexpensive resin as the resin for disposal, when compared with a case where cutting fragments cut off from an expensive resin for the main body are discarded as is done conventionally.

A second aspect of the present invention is characterized in that in the first aspect, the cooling roller is a molding roller in which a concavo-convex pattern of a predetermined shape is formed, and the concavo-convex pattern is transferred onto the resin sheet simultaneously with cooling and solidifying the resin sheet.

The method for manufacturing the molded plate of the present invention can be used effectively in the manufacture of not only a molded plate the thickness of which is uniform in the width direction thereof but also a molded plate having a thickness distribution in the width direction thereof (i.e., the cross-section of which is nonuniform), by forming the concavo-convex pattern on the cooling roller.

A third aspect of the present invention is characterized in that in the first or second aspect, the resin for the main body and the resin for disposal differ in solubility parameter from each other.

According to the third aspect, the resin for the main body and the resin for disposal do not mix with each other in the molten state thereof since the resins differ in solubility parameter from each other. Consequently, it is possible to easily separate the cooled and solidified resin sheet. Further, it is possible to lower manufacturing costs by using a resin less expensive than the resin for the main body as the resin for disposal. Still further, it is possible to improve the recyclability of the resin for disposal since the resin for the main body can be prevented from mixing therewith.

A fourth aspect of the present invention is characterized in that in the third aspect, the difference in solubility parameter is 0.8 or larger but not larger than 1.3.

According to the fourth aspect, it is possible to prevent film separation between the resin for the main body and the resin for disposal since the difference in solubility parameter therebetween is 0.8 or larger but no larger than 1.3. It is also possible to prevent the resins from mixing with each other, or any unreasonable force is not applied at the time of separation and, therefore, surfaces do not become rugged. Consequently, it is possible to flatten the end faces of a resin sheet after a separation step. Accordingly, it is possible to skip a step of polishing the end faces of a resin film.

A fifth aspect of the present invention is characterized in that in any one of the first to fourth aspects, the resin for disposal is laminated in at least three places on the resin for the main body, including both widthwise end parts thereof.

According to the fifth aspect, the resin for disposal is laminated in at least three places on the resin for the main body, including both widthwise end parts thereof. In extrusion molding, the end parts of a resin sheet are cut off to adjust the resin sheet to a desired size before use since the thickness of widthwise end parts of the resin sheet tend to become thin. In the present invention, it is possible to easily manufacture a molded plate to a desired size by separating the resin for disposal, since the end parts are formed of the resin for disposal. In addition, it is possible to easily cut a resin film for the main body at positions where the resin for disposal is arranged, and manufacture a molded plate having flawless end faces, by forming the resin sheet by alternately arranging the resin for the main body and the resin for disposal in the width direction. Consequently, it is possible to easily yield multiple molded plates from one resin sheet.

A sixth aspect of the present invention is characterized in that in any one of the first to fifth aspects, the molded plate is a light guide plate for a liquid crystal display device.

A molded plate manufactured using a manufacturing method of the present invention has smooth cut end surfaces without the need for polishing and can be suitably used as a light guide plate for a liquid crystal display device.

In order to achieve the aforementioned object, a seventh aspect of the present invention provides an apparatus for manufacturing a molded plate, characterized by comprising:

a merging section which merges resins of different types in a molten state, one being a resin for a main body and the other being a resin for disposal;

an extruding die which extrudes the merged resin from a die discharge port in a sheet-like manner;

a cooling and solidification device which nips the resin sheet between a nip roller and a cooling roller to cool and solidify the resin sheet, and then separates the resin sheet from the cooling roller;

a cutting device which cuts the cooled and solidified resin sheet in the width direction thereof; and

a separation device which separates the cut resin sheet into the resin for the main body and the resin for disposal.

An eighth aspect of the present invention is characterized in that in the seventh aspect, the cooling roller is a molding roller on which a concavo-convex pattern of a predetermined shape is formed.

A ninth aspect of the present invention is characterized in that in the seventh or eighth aspect, the resin for the main body and the resin for disposal differ in solubility parameter from each other.

A tenth aspect of the present invention is characterized in that in the ninth aspect, the difference in solubility parameter is 0.8 or larger but not larger than 1.3.

An eleventh aspect of the present invention is characterized in that in any one of the seventh to tenth aspect, the merging section is provided in at least three places in a flow passage through which the resin for the main body flows, including both widthwise end parts of the flow passage.

A twelfth aspect of the present invention is characterized in that in any one of the seventh to eleventh aspects, the molded plate is a light guide plate for a liquid crystal display device.

The seventh to twelfth aspects are the result of developing the methods for manufacturing a molded plate set forth in the first to sixth aspects into an apparatus for manufacturing a molded plate. According to the seventh to twelfth aspects, there can be obtained the same advantages as those of the methods for manufacturing a molded plate.

According to the present invention, it is possible to easily manufacture a molded plate of a desired size by laminating an unnecessary, inexpensive resin not used as a product in the width direction of a molded plate and simply separating the unnecessary resin after forming the molded plate. Consequently, it is possible to skip a step of cutting the molded plate in the machine direction thereof. Further, it is also possible to skip a polishing step since the cut surfaces of the molded plate in the machine direction thereof can be smoothed. Still further, by arranging a plurality of resins for disposal, it is possible to effectively use the resins when yielding multiple molded plates from one resin sheet.

### BRIEF DESCRIPTION OF THE DRAWINGS

FIG. 1 is an overall configuration diagram of an apparatus for manufacturing a molded plate;

FIGS. 2A and 2B are schematic views of an extruding die;

FIGS. 3A and 3B are sectional side views of the extruding die; and

FIGS. 4A and 4B are process drawings used to explain a separation step.

### DESCRIPTION OF SYMBOLS

10: Apparatus for manufacturing molded plate, 11: Resin sheet, 11A: Resin sheet for main body, 11B: Resin sheet for disposal, 12: Extruding die, 14: Cooling roller, 15: Resin film molding device, 16: Nip roller, 18: Separation roller, 20: Cutting device, 22: Separation device, 28, 42: Manifold, 30, 44: Slit, 32: Main body resin flow passage, 34: Disposal resin flow passage, 36: Merging section, 40: Roller, 46: Main body resin feed port, 48: Disposal resin feed port, A: Resin for main body, B: Resin for disposal

### BEST MODE FOR CARRYING OUT THE INVENTION

Hereinafter, a description will be made of preferred embodiments of a method and an apparatus for manufacturing a molded plate according to the present invention, by referring to the accompanying drawings.

<<Apparatus for Manufacturing Molded Plate>>

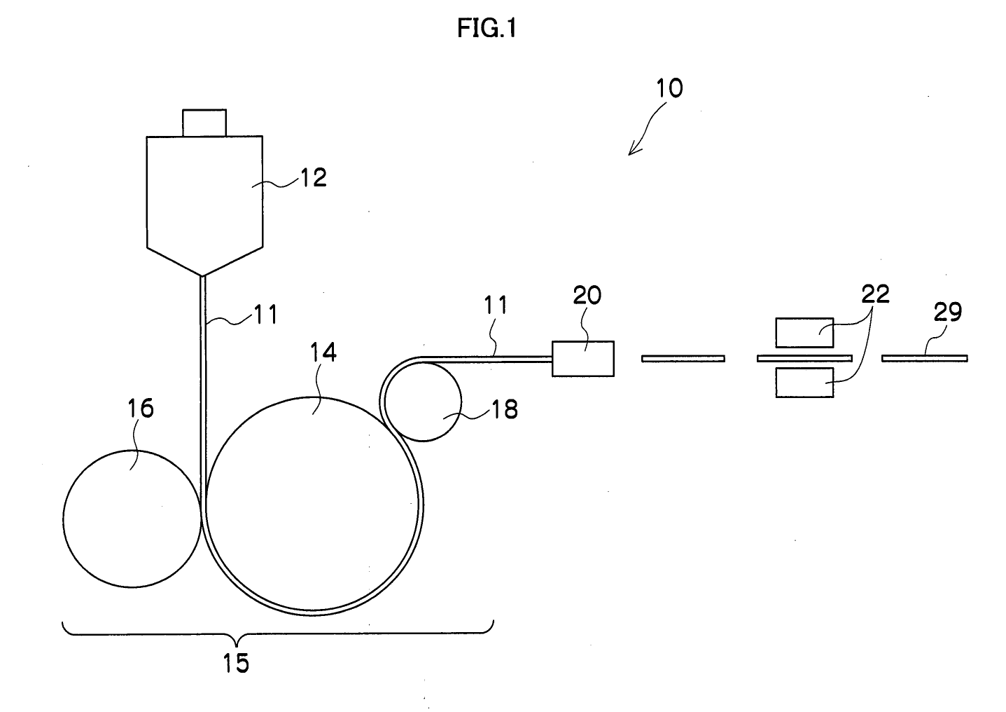

FIG. 1 is an overall configuration diagram of an apparatus for manufacturing a molded plate 10 in the present invention.

As shown in FIG. 1, a cooling roller 14 and a nip roller 16 are adjacently disposed in parallel below an extruding die 12. In addition, a separation roller 18 is adjacently disposed in parallel with the cooling roller 14 on the other side of the nip roller 16 across the cooling roller 14. A resin sheet 11 in a molten state extruded from the extruding die 12 passes through between the cooling roller 14 and the nip roller 16 and between the cooling roller 14 and the separation roller 18, runs in contact with the circumferential surface of the cooling roller 14, and moves away from the cooling roller 14 at the position of the separation roller 18. Consequently, there is manufactured the cooled and solidified self-supporting resin sheet 11. Then, after cutting the resin sheet 11 in the width direction thereof by a cutting device 20 (laser or the like), a force is applied from above and below the resin sheet 11 by a separation device 22. Consequently, the resin sheet is separated in the traveling direction thereof and thus a molded plate 29 is manufactured.

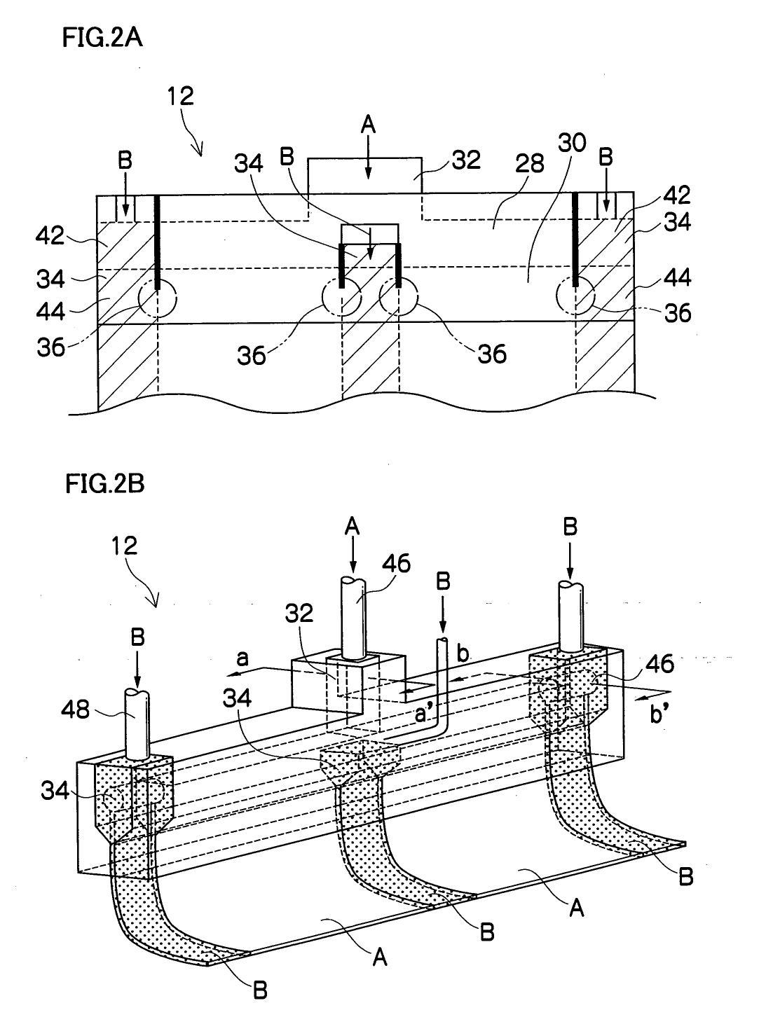

FIGS. 2A and 2B are schematic views of the extruding die 12, wherein FIG. 2A is a front view and FIG. 2B is a perspective view. The extruding die 12 will be described by taking an example in which resins are disposed alternately in the order of a resin for disposal, a resin for the main body, a resin for disposal, a resin for the main body, and a resin for disposal, in the width direction of a resin sheet. As shown in FIGS. 2A and 2B, the extruding die in the present invention is configured into a structure in which the die block of the resin for disposal is contained within the die block of the resin for the main body.

Inside the extruding die 12, there are provided a main body resin flow passage 32 through which a resin for the main body A for forming the resin sheet 11 flows, a disposal resin flow passage 34 through which a resin for disposal B for forming both widthwise end parts and the middle part of the resin sheet 11 flows, and a merging section 36 at which the main body resin flow passage 32 and the disposal resin flow passage 34 merge with each other. In addition, the main body resin flow passage 32 and the disposal resin flow passage 34 merge with each other at the merging section 36, with the thicknesses thereof equal to each other. Consequently, it is possible to form the resin sheet 11 with the thicknesses of the resin for the main body and the resin for disposal equal to each other. Since it is therefore possible to vertically join the end faces of the resin for the main body and the resin for disposal in the thickness direction thereof, the end faces of the resin for the main body can be smoothed after a separation step and, therefore, a subsequent polishing step can be skipped.

The resin for the main body A and the resin for disposal B are merged at the merging section 36, as shown in FIGS. 2A and 2B, while feeding the respective resins to the main body resin flow passage 32 and the disposal resin flow passage 34 and allowing the resins to run in the same direction. Consequently, a boundary face between the resins does not move toward either one of the resin for the main body A and the resin for disposal B when the resins merge with each other and, therefore, it is possible to form the boundary face in parallel with the traveling direction.

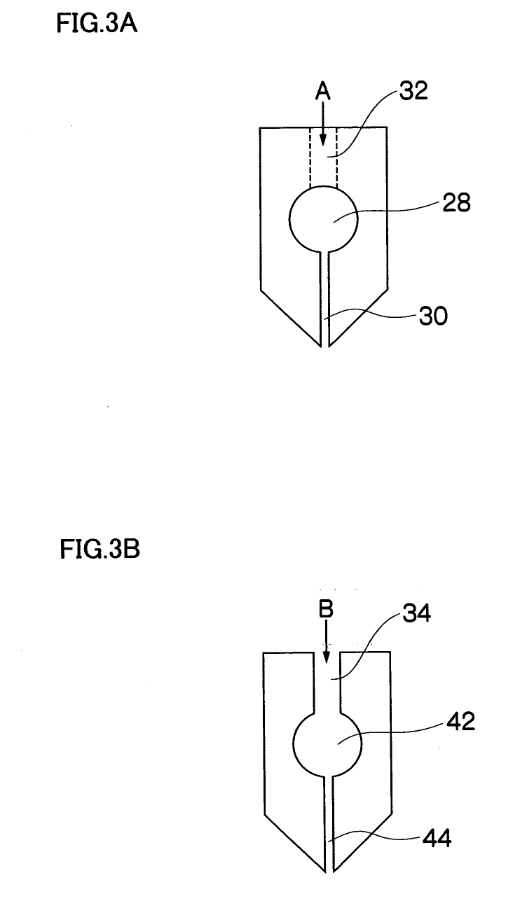

FIGS. 3A and 3B show sectional side views of the extruding die 12, wherein FIG. 3A is a cross-sectional view (main body resin flow passage) taken along the line a-a′ of FIG. 2A and FIG. 3B is a cross-sectional view (disposal resin flow passage) taken along the line b-b′. The main body resin flow passage 32 is configured primarily by a manifold 28 and a slit 30, as shown in FIG. 3A, wherein the flow of the resin for the main body A fed into the extruding die 12 is expanded by the manifold 28 in the width direction of the extruding die 12 (width direction of the resin film 11), and then the resin is extruded to the outside by way of the slit 30.

As shown in FIG. 3B, the resin for disposal B is likewise accumulated within the manifold 42 also at the disposal resin flow passage 34 and is extruded to the outside by way of a slit 44. The merging section 36 is formed by a combination of the slits 30 and 44 of the main body resin flow passage 32 and the disposal resin flow passage 34. In addition, the disposal resin flow passage 34, which is a flow passage for the resin for disposal B formed in the middle of the resin for the main body A, is likewise formed of a manifold and a slit. A manifold for the disposal resin flow passage 34 formed in the middle part is formed within the main body resin flow passage 32. In this case, it is possible to feed the resin for disposal B from the front side of the extruding die 12 as a feed port for the resin, as shown in FIGS. 2A and 2B.

Note that although in FIGS. 2A and 2B, the disposal resin flow passage 34 is formed at the end part and the middle part of the resin film 11, the present invention is not limited to this configuration. Alternatively, the position and the number of disposal resin flow passages 34 can be selected as appropriate depending on the size and the like of a resin film to be manufactured. In addition, the disposal resin flow passage 34 is preferably provided at both end parts of the resin film. Since the end parts of the molded resin film tend to be thinner than a desired thickness, the end parts are cut off before the molded plate is manufactured. Consequently, it is possible to easily cut off unnecessary portions and use a resin sheet manufactured from the resin for the main body as a molded plate by forming the end parts of the resin film with the resin for disposal B.

A resin film molding device 15 is provided with a pair of the rotating cooling roller 14 and the nip roller 16. The resin sheet 11 in a molten state discharged in a sheet-like manner from the extruding die 12 is fed to between these rollers, cooled and solidified on the cooling roller 14, and separated at the position of the separation roller 18. This cooling roller 14 is a molding roller on which a concavo-convex pattern of a predetermined shape is formed, and can cool and solidify a resin sheet while simultaneously transferring the concavo-convex pattern onto the resin sheet. When manufacturing a molded plate the thickness of which is uniform in the width direction thereof, it is possible to use a molding roller on which no concavo-convex patterns are formed.

The cutting device 20 is a device which cuts the cooled and solidified resin sheet 11 separated from the cooling roller 14 by the separation roller 18 in the width direction thereof. The resin sheet is preferably cut by means of online cutting using a CO₂ laser, a YAG laser or the like as the cutting device 20. By applying online cutting, it is possible to easily cut the resin sheet in a short period of time. It is also possible to smooth the cut surfaces of the resin sheet.

The separation device 22 is a device which separates the resin sheet 11 cut in the width direction thereof, into the resin for the main body and the resin for disposal. The resin for the main body separated by the separation device 22 forms into the molded plate 29. Since the resin for the main body and the resin for disposal differ in solubility parameter from each other, it is possible to easily separate the resins from each other by applying force. Consequently, it is possible to easily separate the resins from each other by applying a force to the resin for the main body in a gravitationally downward direction and applying a force opposite to the aforementioned force to the resin for disposal in a gravitationally upward direction.

<<Method for Manufacturing Molded Plate>>

Next, a description will be made of a method for manufacturing a molded plate of the present invention using the apparatus for manufacturing a molded plate 10 configured as described above.

First, an explanation will be made of resins used for the method and apparatus for manufacturing a molded plate of the present invention. The manufacturing method of the present invention is carried out by using the resin for the main body A and the resin for disposal B, wherein the resin for the main body A is a resin to serve as a raw material of an extrusion-molded plate, and the resin for disposal B is a resin for aiding the manufacture of the extrusion-molded plate and is disposed of after manufacture. The resin for the main body A and the resin for disposal B preferably differ in solubility parameter (hereinafter also referred to as “SP value”) from each other and, more preferably, the difference in solubility parameter is 0.8 or larger but not larger than 1.3, still more preferably, 1.0 or larger but not larger than 1.2. By setting the solubility parameter to within the above-described range, the resins are prevented from mixing with each other in their molten state. In addition, it is possible to prevent the film separation of the resin for the main body A and the resin for disposal B in a cooling and solidification step and in a cutting step. Further, since the resins do not mix with each other or any unreasonable force is applied at the time of separation and, therefore, surfaces are not roughened, it is possible to maintain the flatness of the end faces of the resin for the main body and the resin for disposal. Accordingly, it is possible to use the end faces as planes of incidence without the need for polishing and, therefore, skip a polishing step. Still further, by preventing film separation, it is possible to maintain the adhesion properties of a resin film main body and a resin film disposal part in a separation step until an external force is applied to the extrusion-molded plate.

As the resin for the main body A of such resins as described above, a polymethylene methacrylate resin, a polycarbonate resin, a polystyrene resin, an MS resin, a cycloolefin resin, or the like may be used. The resin for the main body A is not limited to these resins in particular, however, as long as the resin has transparency and can be used for a light guide plate or the like. As the resin for disposal B, a polyethylene resin, a polypropylene resin, a polyvinyl chloride resin, a polyurethane resin, a polyethylene terephthalate resin, or the like may be used. Of these resins, a polymethylene methacrylate resin or a polycarbonate resin is preferably used as the resin for the main body A and a polyethylene resin or a polypropylene resin is preferably used as the resin for disposal B. In addition, a polymethylene methacrylate resin and a polyethylene resin are most preferably used as a combination of the resin for the main body A and the resin for disposal B. Although a plurality of resins can be used for each resin, it is preferable to use a separate resin as the resin for disposal B, in order to improve the recyclability thereof. The resin for disposal B is not limited to any particular resin as long as the resin is extrudable.

An extrusion step is performed by extruding these resins from the extruding die 12. The resin for the main body A is injected into a main body resin feed port 46, the flow of the resin is expanded within the manifold 28 in the width direction of the resin sheet, and the resin is extruded by way of the slit 30. Likewise, the resin for disposal B is injected into a disposal resin feed port 48, the flow of the resin is expanded within the manifold 42 in the width direction of the resin sheet, and the resin is extruded by way of the slit 44. The resin for the main body A and the resin for disposal B merge with each other at the merging section 36 when passing through the slits 30 and 44, and are joined and extruded. If extruded at a high rate at this time, the resin film becomes liable to film separation and it becomes difficult for the resin for the main body and the resin for disposal to adhere to each other. It is therefore preferable to extrude the resin film by controlling the rate of extrusion. Specifically, extrusion is preferably performed at a rate of 0.2 cm/s or higher but not higher than 20 cm/s, though this depends on the type of resin.

The resin sheet 11 extruded from the extruding die 12 is nipped between the nip roller 16 and the cooling roller 14 and cooled and solidified by the cooling roller 14 in a resin film molding step, thereby forming the cooled and solidified resin sheet 11. Then, the resin sheet 11 is separated from the cooling roller 14 by the separation roller 18, followed by the subsequent step of cutting the resin sheet 11.

The cutting step is a step of cutting the resin sheet 11 in the width direction thereof. The cutting step is preferably performed by means of the above-described online cutting. By cutting the resin sheet 11 by means of online cutting, it is possible to smooth cut surfaces and therefore skip a polishing step.

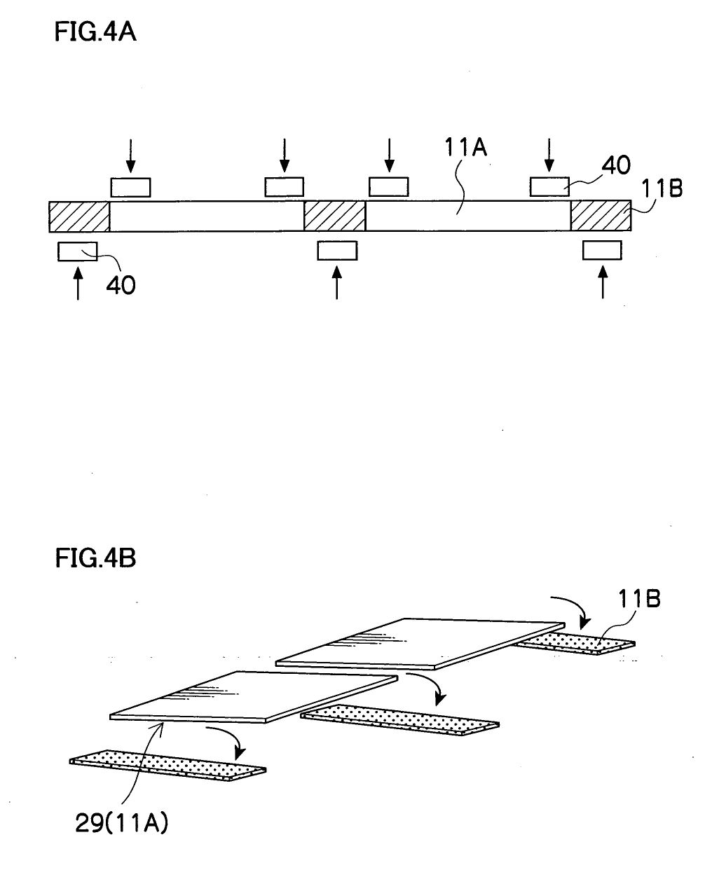

Finally, the resin for the main body and the resin for disposal of the cut resin sheet are separated from each other by separation device. Consequently, the resin for the main body forms into the molded plate 29 whose boundary surfaces facing the resin for disposal are smooth and flat. FIGS. 4A and 4B show process drawings of the separation step. Since a resin sheet for a main body 11A and a resin sheet for disposal 11B are manufactured using resins having different solubility parameters, it is possible to easily separate the resin sheets from each other by applying an external force. Accordingly, by applying a force with a roller 40 to the resin sheet for the main body 11A from the upper side thereof and applying a force with the roller 40 to the resin sheet for disposal 11B from the lower side thereof, as shown in FIG. 4A, it is possible to easily separate the resin sheets from each other as shown in FIG. 4B. It is therefore possible, in the present invention, to skip a step of cutting in the machine direction and thereby improve productivity.

In addition, since the resins differ in solubility parameter from each other, it is possible to manufacture a molded plate without allowing the resins to mix with each other. Thus, it is possible to smooth post-separation boundary surfaces. Consequently, it is possible to use the boundary surfaces as planes of incidence without the need to perform a polishing step and, therefore, the molded plate can be suitably used as a light guide plate of a liquid crystal display device. In addition, it is possible to skip a polishing step and thereby improve productivity.

Note that it is possible to adjust the size of the molded plate by arranging a plurality of the resins for disposal in the width direction of the molded plate. It is also possible to manufacture a multitude of extrusion-molded plates without having to perform a cutting step and, therefore, this arrangement is also effective in yielding multiple molded plates from one resin sheet.

While in the present embodiment, an explanation has been made by taking an example of manufacturing the extrusion-molded plate only with the resin film 11, the manufacturing method can also be used for a film-like laminated body in which the resin film 11 is laminated on a substrate.

### EXAMPLES

Hereinafter, an explanation will be made of the substantial advantages of the present invention by way of examples.

### Comparative Example 1

The manufacture of an extrusion-molded plate was carried out using a nip roller whereby two reverse wedge-shaped extrusion-molded plates can be obtained in the width direction thereof A resin prepared by mixing a light-diffusing resin into a polymethylmethacrylate (PMMA) resin was used. Subsequently, the extrusion-molded plate was cut online in the width direction and the machine direction thereof, to obtain a light guide plate of a desired size. After that, the extrusion-molded plate was manufactured by polishing cut surfaces using a mechanical polishing method, so that the cross-section thereof was Ra: 0.05 μm.

### Test Example 1

### Resin for Main Body: PMMA Resin

### Examples 1 to 3

### Comparative Examples 2 to 5

In order to obtain the same extrusion-molded plate as that of comparative example 1, molding was carried out using the same nip roller. As the resin for the main body, a resin (SP value: 9.2) prepared by mixing a light-diffusing resin into a polymethylmethacrylate (PMMA) resin was used, as in comparative example 1. In addition, resins shown in Table 1 were laminated in three places (both ends and the middle) in the width direction as resins for disposal. Note that, the resins for disposal were used without mixing a light-diffusing resin thereinto. After extrusion molding, a resin sheet was cut online in the width direction thereof using a CO₂ laser and the resin for disposal was separated off, thereby obtaining a light guide plate of a desired size.

Test results are shown in Table 1. In addition, the SP values of the resins used are shown in Table 2.

TABLE 1

| | | | Difference in | |
|---|---|---|---|---|
| | | | SP value | |
| | Resin for | Resin for | (absolute | |
| | main body | disposal | value) | Result |
| Example 1 | PMMA | Polypropylene | 1.3 | OK |
| Example 2 | PMMA | Polyethylene | 1.2 | OK |
| Comparative | PMMA | PMMA | 0 | Closely |
| example 2 | | | | adhered |
| Comparative | PMMA | Polystyrene | 0.2 | Closely |
| example 3 | | | | adhered |
| Comparative | PMMA | Polyvinyl | 0.4 | Closely |
| example 4 | | chloride | | adhered |
| Example 3 | PMMA | Polyurethane | 0.8 | OK |
| Comparative | PMMA | Polyethylene | 1.5 | Peeled off |
| example 5 | | terephthalate | | |

TABLE 2

| Resin name | SP value |
|---|---|
| Polypropylene | 7.9 |
| Polyethylene | 8.0 |
| Polystyrene | 9.0 |
| PMMA | 9.2 |
| Polyvinyl chloride | 9.6 |
| Polyurethane | 10.0 |
| Polyethylene | 10.7 |
| terephthalate | |

### Test Example 2

### Resin for Main Body: Polystyrene Resin

Using a polystyrene resin as the resin for the main body, a light guide plate was manufactured in the same way as in test example 1, except that resins shown in Table 3 were used as resins for disposal. Test results are shown in Table 3.

TABLE 3

| | | | Difference in | |
|---|---|---|---|---|
| | | | SP value | |
| | Resin for main | Resin for | (absolute | |
| | body | disposal | value) | Result |
| Example 4 | Polystyrene | Polypropylene | 1.1 | OK |
| Example 5 | Polystyrene | Polyethylene | 1.0 | OK |
| Comparative | Polystyrene | Polyvinyl | 0.6 | Closely |
| example 6 | | chloride | | adhered |
| Example 6 | Polystyrene | Polyurethane | 1.0 | OK |
| Comparative | Polystyrene | Polyethylene | 1.7 | Peeled off |
| example 7 | | terephthalate | | |

<Results>

In comparative example 1, which represents a conventional method, the extrusion-molded plate was cut in the machine direction. The method further required polishing cut surfaces and, therefore, the productivity thereof proved inferior to that of embodiment 1. In addition, the degree of roughness Ra of a boundary surface between a resin film main body and a resin film disposal part in embodiment 1 was 0.02 μm, thus exhibiting cross-sectional roughness smaller than that of comparative example 1, without the need to perform a polishing step.

In addition, in comparative examples 2 to 4 and 6 in which the solubility parameter difference was smaller than 0.8, the resin for the main body and the resin for disposal were in close contact with each other without peeling off from each other. In comparative examples 5 and 7 in which the difference in solubility parameter was larger than 1.3, the resins peeled off from each other immediately after cooling, thus showing difficulties in operating the apparatus.

As has been described heretofore, the difference in solubility parameter is preferably set to 0.8 or larger but not larger than 1.3.

1. A method for manufacturing a plurality of molded plates formed to a desired size from a resin for a main body, the method characterized by comprising:
an extrusion step of merging resins of different types in a molten state, one being a resin for a main body and the other being a resin for disposal, and extruding the resins from a die in a sheet-like manner, thereby forming a resin sheet in which the resin for the main body and the resin for disposal are alternately disposed in the width direction of the resin sheet;
a cooling and solidifying step of cooling and solidifying the resin sheet by nipping the resin sheet between a nip roller and a cooling roller and then separating the resin sheet from the cooling roller;
a cutting step of cutting the cooled and solidified resin sheet in the width direction thereof; and
a separation step of separating the cut resin sheet into the resin for the main body and the resin for disposal.

2. The method for manufacturing according to claim 1, characterized in that the cooling roller is a molding roller in which a concavo-convex pattern of a predetermined shape is formed, and the concavo-convex pattern is transferred onto the resin sheet simultaneously with cooling and solidifying the resin sheet.

3. The method for manufacturing according to claim 1, characterized in that the resin for the main body and the resin for disposal differ in solubility parameter from each other.

4. The method for manufacturing according to claim 3, characterized in that the difference in solubility parameter is 0.8 or larger but not larger than 1.3.

5. The method for manufacturing according to any one of claim 1, characterized in that the resin for disposal is placed in at least three places on the resin for the main body, including both widthwise end parts thereof.

6. The method for manufacturing according to claim 1, characterized in that the molded plate is a light guide plate for a liquid crystal display device.

7. An apparatus for manufacturing a molded plate, characterized by comprising:
a merging section which merges resins of different types in a molten state, one being a resin for a main body and the other being a resin for disposal;
an extruding die which extrudes the merged resin from a die discharge port in a sheet-like manner;
a cooling and solidification device which nips the resin sheet between a nip roller and a cooling roller to cool and solidify the resin sheet, and then separates the resin sheet from the cooling roller;
a cutting device which cuts the cooled and solidified resin sheet in the width direction thereof; and
a separation device which separates the cut resin sheet into the resin for the main body and the resin for disposal.

8. The apparatus for manufacturing a molded plate according to claim 7, characterized in that the cooling roller is a molding roller on which a concavo-convex pattern of a predetermined shape is formed.

9. The apparatus for manufacturing a molded plate according to claim 7, characterized in that the resin for the main body and the resin for disposal differ in solubility parameter from each other.

10. The apparatus for manufacturing a molded plate according to claim 9, characterized in that the difference in solubility parameter is 0.8 or larger but not larger than 1.3.

11. The apparatus for manufacturing a molded plate according to claim 7, characterized in that the merging section is provided in at least three places in a flow passage through which the resin for the main body flows, including both widthwise end parts of the flow passage.

12. The apparatus for manufacturing a molded plate according to claim 7, characterized in that the molded plate is a light guide plate for a liquid crystal display device.
